(19) United States
(12) Patent Application Publication
(10) Pub. No.: US 2016/0350808 A1
(43) Pub. Date: Dec. 1, 2016

(54) RETAIL PROMOTION SYSTEM BASED ON PHYSICAL PROXIMITY ENTRY AND REWARD

(71) Applicants: Xiaohong Zhang, Clayton, MO (US); Michael Saigh, Clayton, MO (US)

(72) Inventors: Xiaohong Zhang, Clayton, MO (US); Michael Saigh, Clayton, MO (US)

(21) Appl. No.: 14/722,108

(22) Filed: May 26, 2015

(51) Int. Cl. G06Q 30/02; H04W 8/00; H04W 4/02

(52) U.S. Cl. CPC G06Q 30/0261; H04W 4/021; H04W 8/005; G06Q 30/0267

(57) ABSTRACT

The described embodiments provide systems and methods for creating real-time or near-time promotions information and marketing databases based-on scalable geographic proximity. The system processes communications from plurality of retailers to draw customers to their physical location based on competitive promotions and product and or service discounts. The system includes multiple “Field Units” which capture geo-coded and time stamped promotions, discounts and marketing data and other data and communications. The data can be retrieved and accessed through a plurality of communications networks for analysis, feedback used for decision making. The Time Expiration Marketing Proximity and Traffic (TEMPT) disseminates information, when potential customers enter into physical promises, to mobile devices in close geographic proximity of one or more locations, including but not limited to indoor and/or outdoor geo-grids. The TEMPT system is customizable to meet the need of an organization's strategic marketing focus designed to increase sales revenue, inventory turns, impulse purchases, customer traffic and other information in one or more targeted geographic campuses. Potential customers can use on/off switch to search or block information.

The TEMPT system is capable of disseminating information regarding products, services and other information in order to create a virtual time-based promotional and dynamic informational feed. The mobile device can detect a plurality of nodes and location access points configured to provide a perimeter map of a campus in one or more geographic locations. The TEMPT system can allow customers in close geo-proximity to a campus location or inside campus to receive specific product and/or service information through one or more concentric databases.

### BACKGROUND

This application is an utility application titled “Time-Based Virtual Access and Retrieval Based on Geographic Proximity”, and the teachings of which are incorporated herein in their entireties by reference. This application claims the benefit of the filing date of U.S. provisional application filed on date May 27, 2014.

The present disclosure relates to a smart dynamic database which captures, gathers and analyzes a multitude of Time Expiration Marketing Proximity and Traffic (TEMPT), through a various secure wireless locator technology and access points, use for outdoor and/or indoor position, including but not limited to GPS or AVL positioning and other inputs for the purpose of expeditious response, access and retrieval of transferred data. These technologies interface for one or more mobile smart devices, for example: push data mono-directionally, and/or bi-directionally on one or more mobile devices receiving can access information from controlled/managed network of system and/or sub-systems, a central databases and/or combination of plurality of information networks.

An example of one embodiment of the TEMPT system could detect customers entering/crossing into the perimeter of campus. Campuses can be defined as Mall, School, Industrial Complex, Government Entities, Urban or Rural geographic location and retail locations or other topographical location. Time sensitive discount and marketing information based on how fast customer walking into the physical premises

It is understood by anyone who is familiar with art, that all X-Y-Z coordinates, campus maps and location calculations can be analyzed through a multitude of positioning technologies. These include WLAN, and other wireless local network, radio waves for communication between nodes or access points, sensors, GPS enable devices, triangulation and signal strength received from various access points between center and receivers, etc.

TEMPT incentive to time sensitive discounts and could be prorated discount. It could be dynamically changed base on traffic. Currently market inefficiency are results of the lack of an individual focused informational system. The current system is largely based on “one size fits all”, and doesn't differentiate:
Individual shopping habits and experience
Individual travel patterns and experiences
Individual desire of seeking value and saving
Individual desire for time efficiency
Individual preferences for product and service

### SUMMARY

Time Expiration Marketing Proximity and Traffic (TEMPT) could be defined by one embodiment as the ability to detect a campus through various smart devices when crossing a certain location's perimeter in order to gather specific information, based on customized individual needs and specific request or searches. TEMPT helps resolve individual needs and requirements for products and services by providing greater efficiency, and or provide time sensitive information on price discount, exemplified by the following:
A customized sellers/buyers information dynamic
Perimeter mapping and/or indoor/outdoor positioning to provide guidance (geo-proximity position)
Time-based buyer/seller transaction urgency
Providing promotions based on purchase time-limitation relative to geo-proximity
Tailored product and service information based on individual buying preferences
Customized discounts based on individual and/or family products and service needs.
Competitive price information based on real-time or near-time information.
The system processes communications from plurality of retailers to draw customers to their physical location based on competitive promotions and product and or service discounts.
Other speed of physical retail entry based on promotion.

TEMPT provides potential customers for selections of specific products or service and or several time sensitive discounts. For specifically, the TEMPT system could include a series of events resulting from the detection or the crossing of a campus perimeter. One scenario could include for example, the following:

The smart device could enable or disable information through software settings including but limited to:
enabling or disabling a campus map (2D, 3D, Holographic, Video, drawing, photos, etc.) of one or more organizations or entities.
enabling or disabling the ability to query and search, such as but not limited to the request of certain information regarding one or more entities within the campus.
   requesting product information of one or more product types or NAICS classifications, or SKU's or International equivalent, including but not limited to discount information and other information based on a customer's product and or service need or interest.
   requesting like product (SKU) information from entities within the campus such as price comparisons, alternative like products and features, availability (inventory stock-outs), etc.
enabling or disabling promotions, sales information, discounts and coupons, and other information from one or more entities within the campus.
enabling or disabling indoor positioning and tracking when on the campus
enabling or disabling future promotions.
enabling or disabling the ability of the entities and or the organization ability to gather personal data regarding the purchase, information request and other consumer behavioral aspects regarding their private information.
enabling or disabling the ability to erase all private sourcing by campus entities, organizations or technological enablers to ID the customer purchasing behavior, location (GPS, etc.) tracing points and other related information.
enabling or disabling any type of alert regarding of any situation to individual preferences
enabling or disabling personal safety alert notification
enabling or disabling information sharing and social networking
enabling or disabling campus mapping
competitive promotions based on time-based expiration
enabling or disabling customer guidance system when on campus, including but not limited to indoor location or outdoor location tracking.

### BRIEF DESCRIPTION

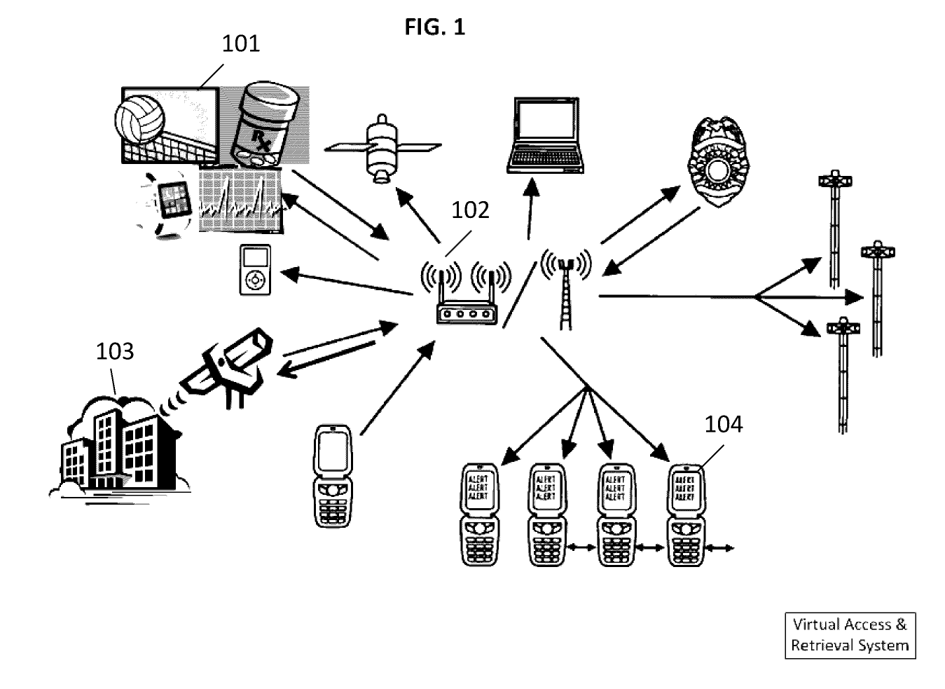

FIG. 1 shows a block diagram of a system employing one or more of the mobile devices of virtual access and retrieval system for a plurality of various geographic vectors, determining information prioritization and competitive positioning, in accordance with embodiments of the present invention.

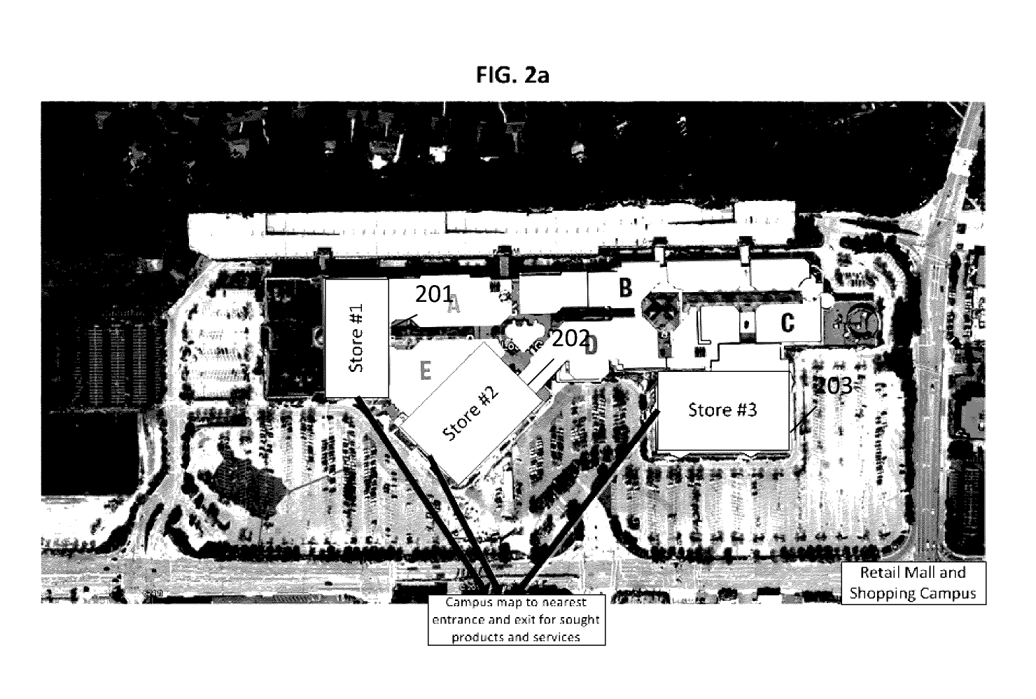

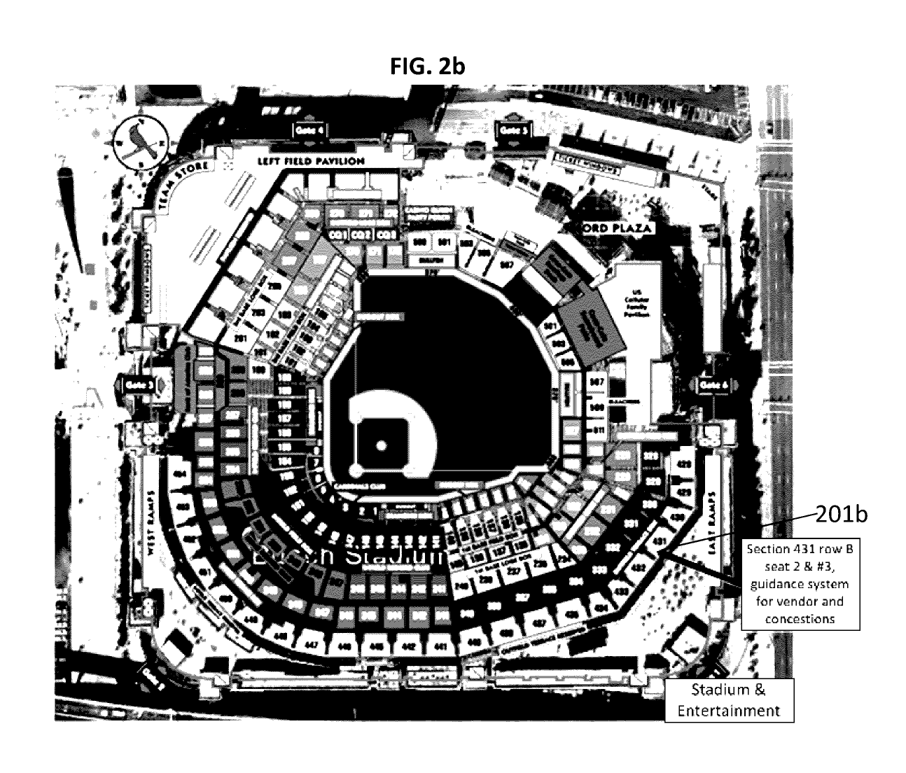

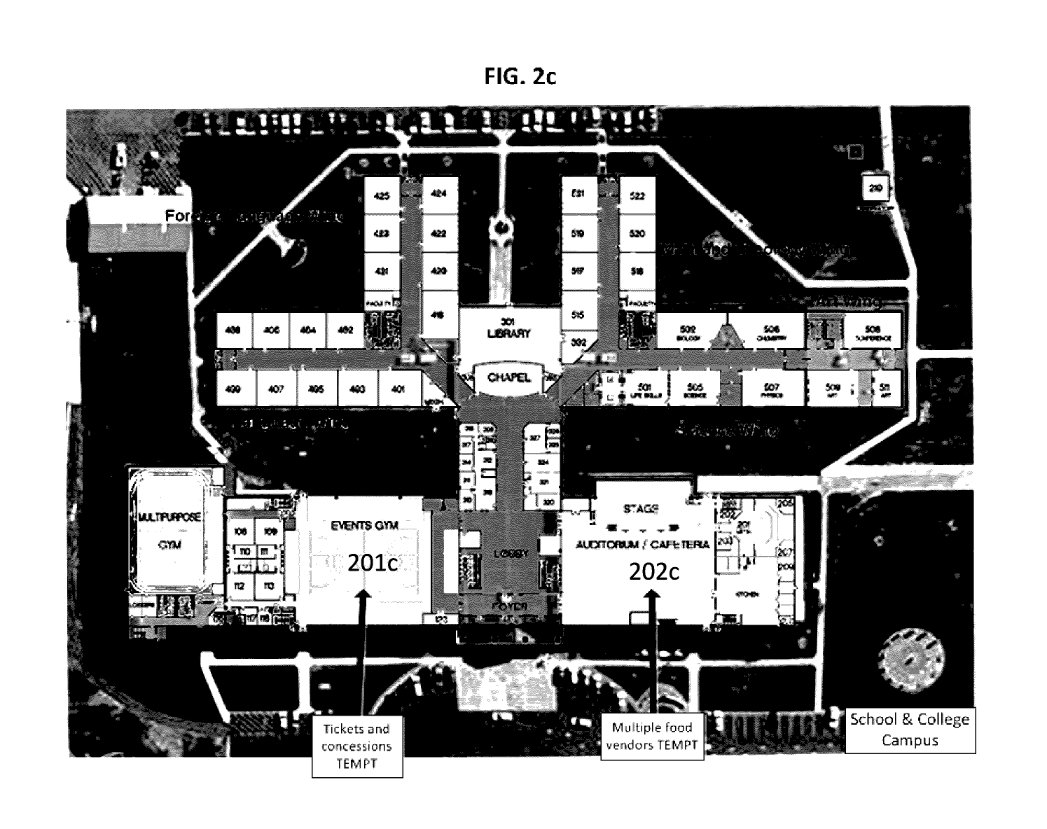

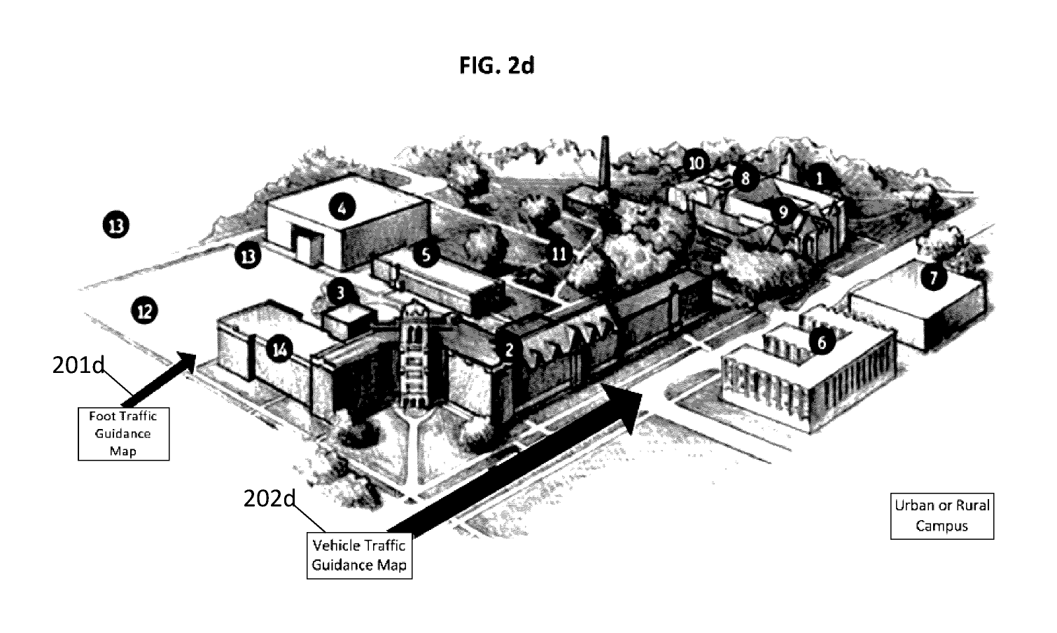

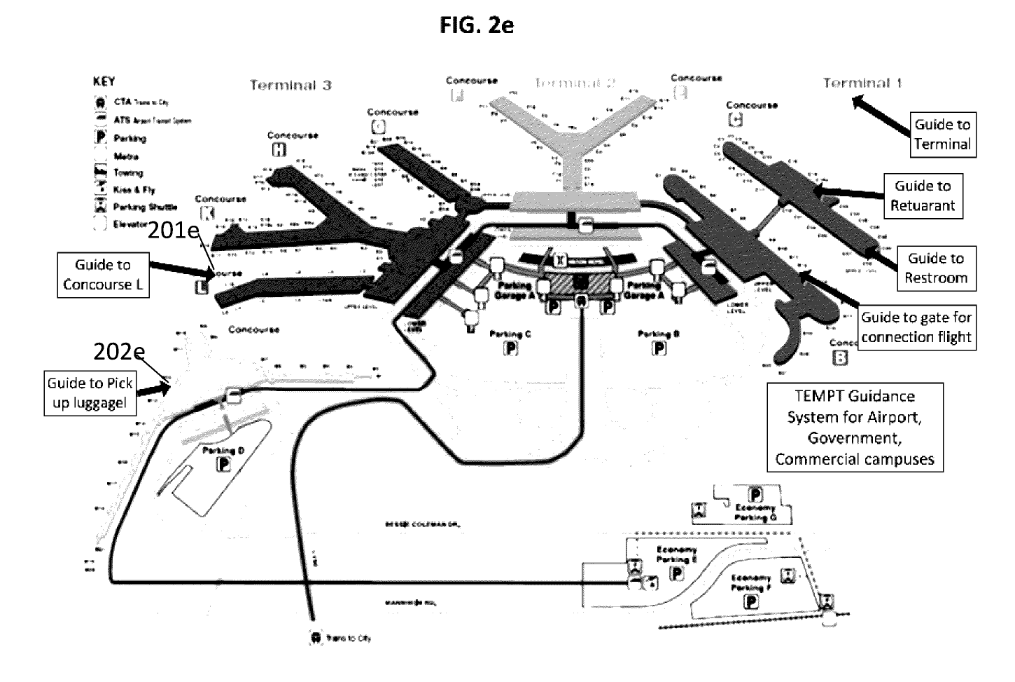

FIG. 2a is an example of a Retail Mall or Shopping campus as a block diagram of an exemplary virtual representation of physical campus having outside and/or an inside perimeter and based on one or more mobile or geographic concentric positions, in accordance with embodiments of the present invention.

FIG. 2b is an example of a Stadium and Entertainment campus as a block diagram of an exemplary virtual representation of physical campus having outside and/or an inside perimeter and based on one or more mobile or geographic concentric positions, in accordance with embodiments of the present invention.

FIG. 2c is an example of a K-12 School or College campus as a block diagram of an exemplary virtual representation of physical campus having outside and/or an inside perimeter and based on one or more mobile or geographic concentric positions, in accordance with embodiments of the present invention.

FIG. 2d is an example of an Urban or Rural campus as a block diagram of an exemplary virtual representation of physical campus having outside and/or an inside perimeter and based on one or more mobile or geographic concentric positions, in accordance with embodiments of the present invention.

FIG. 2e is an example of an Airport, Government, Commercial campuses as a block diagram of an exemplary virtual representation of physical campus having outside and/or an inside perimeter and based on one or more mobile or geographic concentric positions, in accordance with embodiments of the present invention.

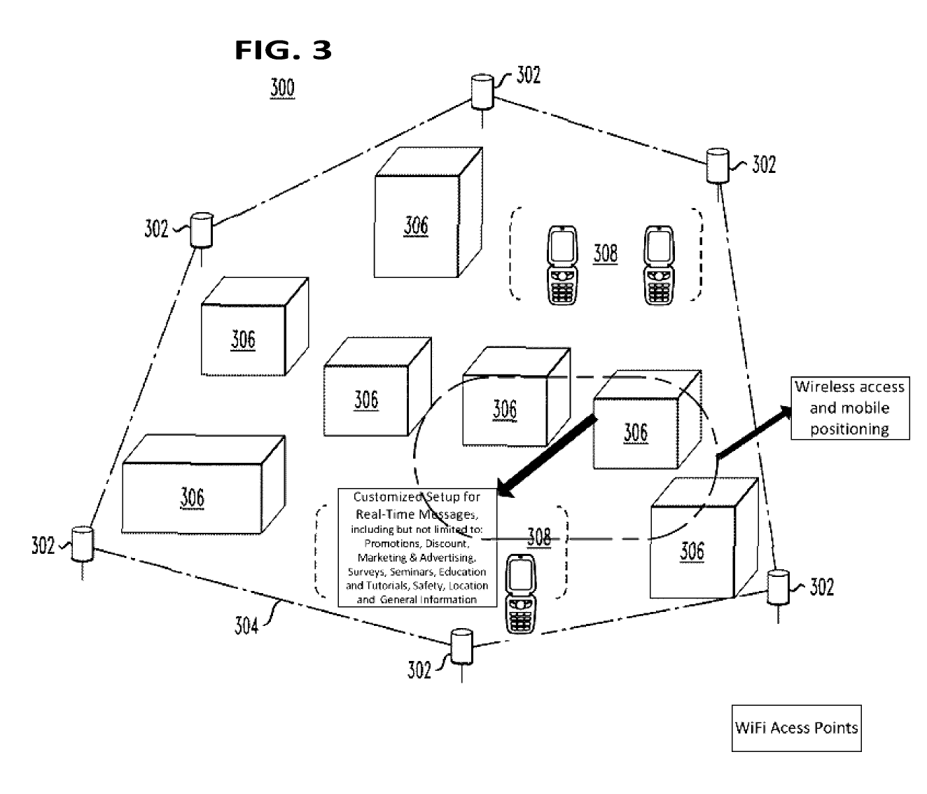

FIG. 3 is an example of wireless access and mobile positioning based on individual customizable product and/or service needs and correlating information from on campus providers of these products and/or services, in accordance with embodiments of the present invention.

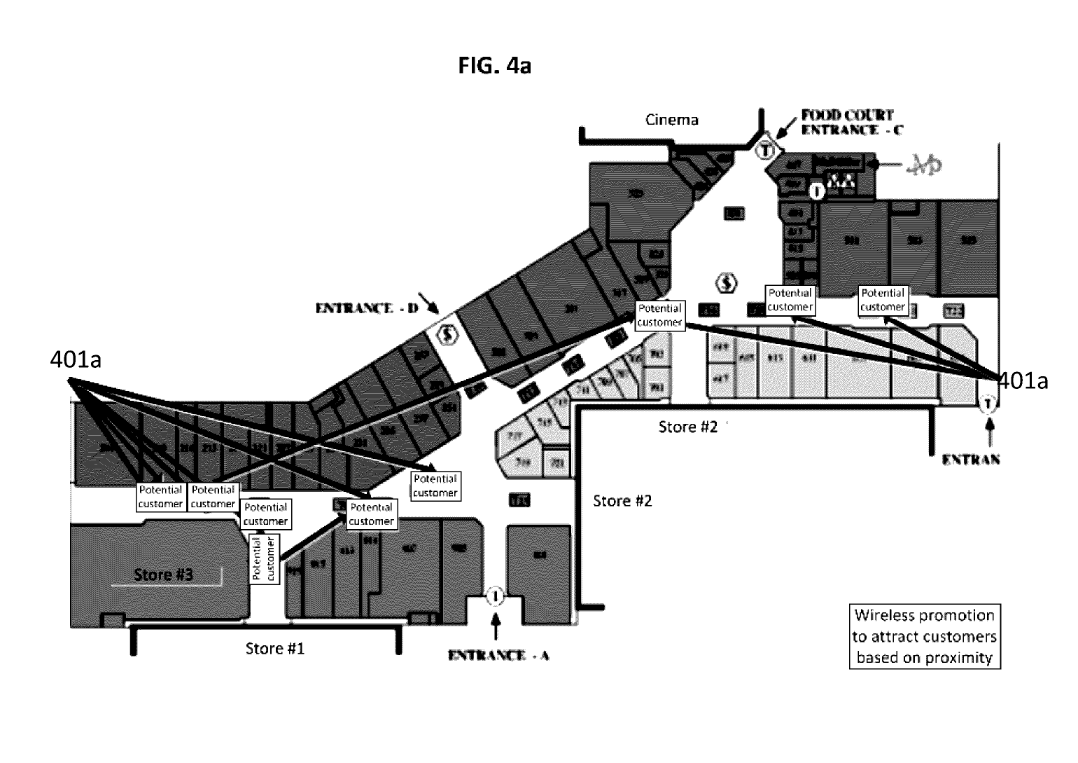

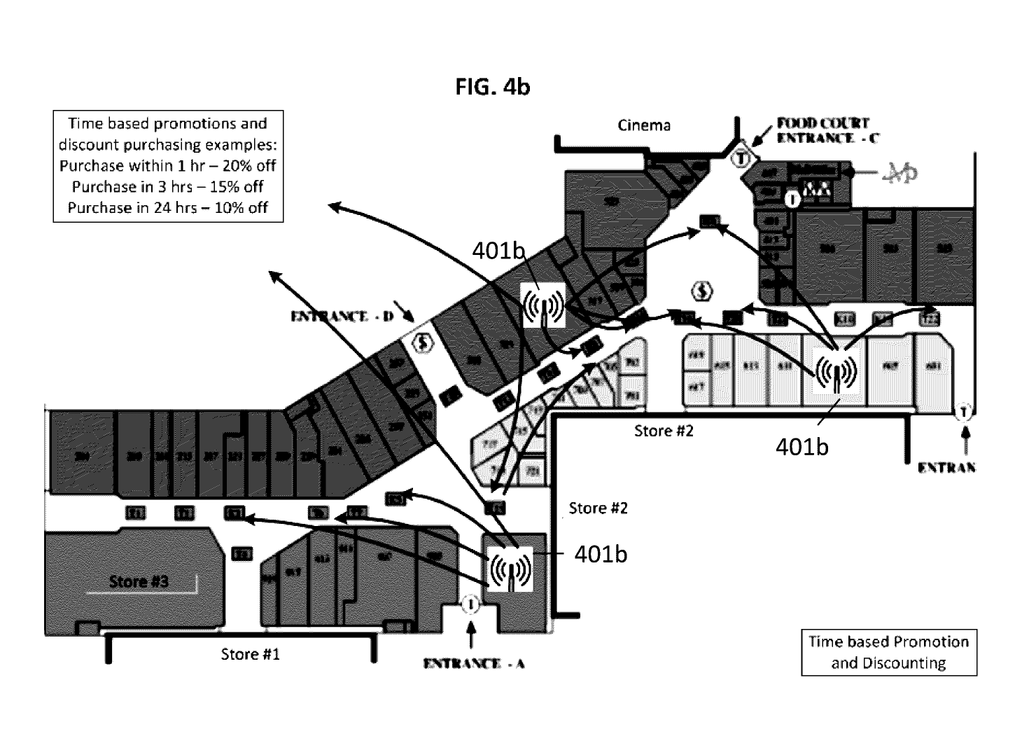

FIG. 4a is an example of a wireless promotion to attract customers based on mobile positioning and individual product and/or service needs and correlating geo-proximity, in accordance with embodiments of the present invention.

FIG. 4b is an example of a time-based promotion and discounted purchasing with pre-set requirements, in accordance with embodiments of the present invention.

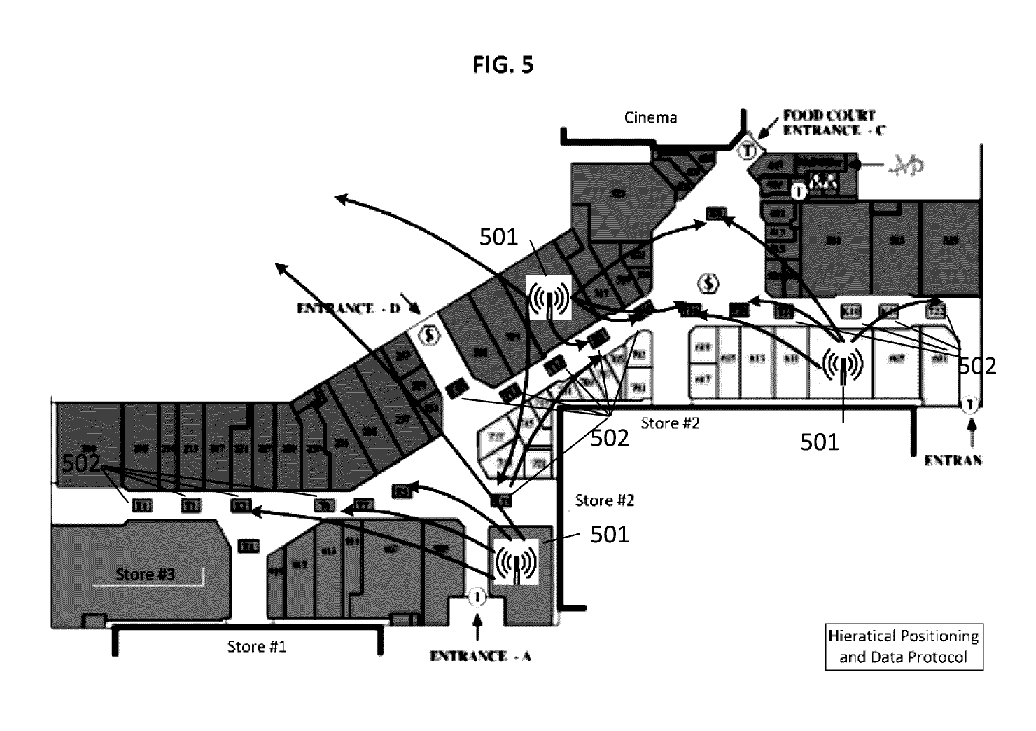

FIG. 5 is an example of creating a hieratical promotional order to distinguish one seller's position over other sellers, for example, the first position could require a premium cost over the second and third position, etc.

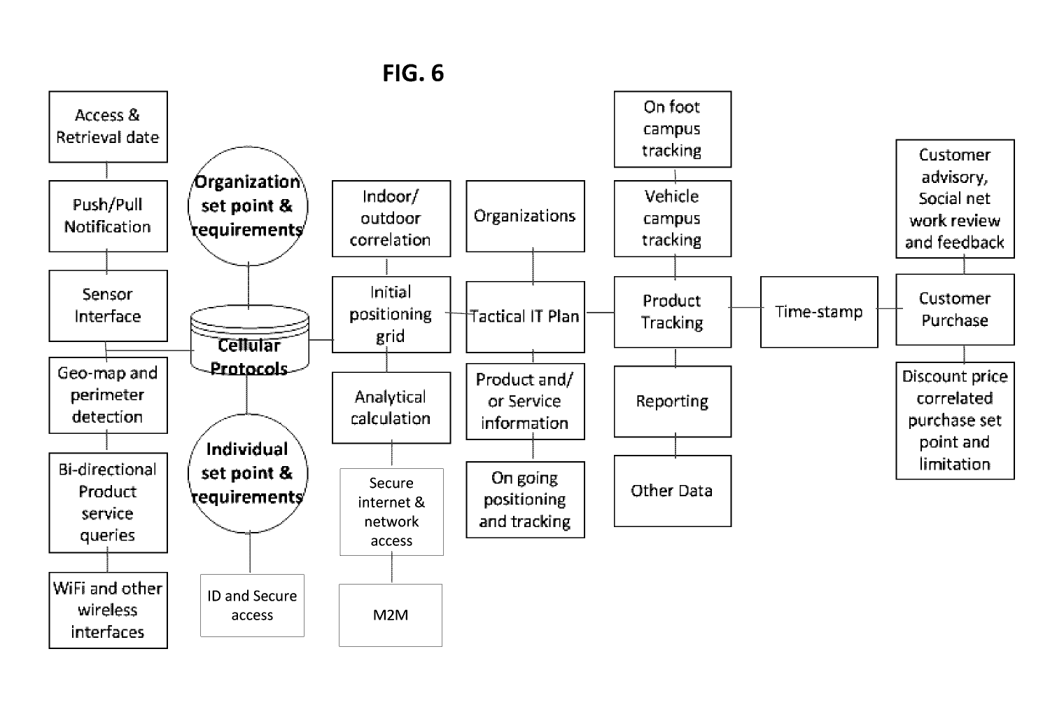

FIG. 6 is an example of overall TEMPT system, in accordance with embodiments of the present invention.

### DETAIL DESCRIPTION

FIG. 1 shows a block diagram of a system employing one or more of the mobile devices of virtual access and retrieval system for a plurality of various geographic vectors, determining information prioritization and competitive positioning, in accordance with embodiments of the present invention;

FIG. 101 shows a retail store or stores attached or configured sending promotional messages/signals. The marketing or promotional message (TEMPT) could be networked in order to send a multitude of information, to any type of wireless 102 devices as shown in FIG. 104. In addition, FIG. 103 represents any mechanism including but limited to infrared devices which could transmit and disseminate information through the network for all types of purposes. Mobile devices can receive notifications in a predetermined physical proximity, such as but not limited to: promotions, discounts, marketing, advertising, seminars, surveys, educational information, tutorial, safety, mapping (2D, 3D, holographic, pictures, video or sequential events for all media types and protocols) for location based information and events. Various servers could be customized in order to increase sales and revenue and transactions. In addition, the system could collect real-time or near-time information such as but not limited to: shopping experience, purchasing activities, consumer behavior and other marketing data. Each mobile device is capable of seamlessly interfacing customized protocols for school campuses, corporate complexes, industrial centers, governmental buildings, retail developments, cities, municipalities, sports stadiums and other organizations or properties (generally, a “campus”) topographical and geographical perimeters. The general public real-time mobile marketing system automatically converts when crossing the established geo-graphic perimeters to a mobile system designed specifically to a particular campus. Each mobile system could be pre-programmed and can be tailored to the “campus” protocols and specific marketing requirements for one or more entities as needed.

FIG. 2a is an example of a Retail Mall or Shopping campus as a block diagram of an exemplary virtual representation of physical campus having outside and/or an inside perimeter and based on one or more mobile or geographic concentric positions, in accordance with embodiments of the present invention. 201 and 202 and 203 are competing stores selling same category products with TEMPT providing time sensitive discounts or marketing information.

FIG. 2b is an example of a Stadium and Entertainment campus as a block diagram of an exemplary virtual representation of physical campus having outside and/or an inside perimeter and based on one or more mobile or geographic concentric positions, in accordance with embodiments of the present invention. 201b demonstrates guidance system for vendor and concessions.

FIG. 2c is an example of a K-12 School or College campus as a block diagram of an exemplary virtual representation of physical campus having outside and/or an inside perimeter and based on one or more mobile or geographic concentric positions, in accordance with embodiments of the present invention. 201c demonstrates TEMPT system for tickets and concessions, 202c demonstrates multiple food vendors with using TEMPT system.

FIG. 2d is an example of an Urban or Rural campus as a block diagram of an exemplary virtual representation of physical campus having outside and/or an inside perimeter and based on one or more mobile or geographic concentric positions, in accordance with embodiments of the present invention. 201d demonstrates TEMPT providing food traffic map, 202d demonstrate TEMPT providing vehicle traffic guidance map.

FIG. 2e is an example of an Airport, Government, Commercial campuses as a block diagram of an exemplary virtual representation of physical campus having outside and/or an inside perimeter and based on one or more mobile or geographic concentric positions, in accordance with embodiments of the present invention. 201e demonstrates TEMPT providing directional guide to specific concourse. 202e demonstrates TEMPT providing directional guide to pick up luggage.

Outside and/or an inside perimeter and based on one or more mobile or geographic concentric positions, could be set by one or more dynamic X-Y or X-Y-Z perimeters (such as length, width and height), and/or 3 dimensional and/or holographic data points. X-Y or X-Y-Z coordinates of campus perimeter are entered and mapped outlining the outside and/or inside the perimeter in every direction. Enriched data sourcing and product location technology will enhance competitive marketplace, which include but not limited to business trade, commercial trade and retail trade, bartering and all merchandising.

The perimeter of campus might be defined as, for example, the property line which borders non-campus property. As shown in FIG. 2, campus might be represented by a campus map and topography with buildings, structures, roadways, sidewalks, parking areas, etc. (shown generally as structures and areas). Campus might so generally be at least one university or school campus, office complex, company headquarters, industrial park, sports stadium, retail shopping complex or mall, cities buildings, a park, or any other such geography. X-Y or X-Y-Z location data and GPS coordinates for campus perimeter are communicated to and stored on a server, for example integrated customer database to one or more businesses or entities, for communication with an individual's smartphone and or mobile device application. The campus buildings, parking lots, structures, sidewalks, roadways and other geographical features are superimposed within the virtual X-Y or X-Y-Z perimeter as shown by structures and areas. When a smartphone user drives or walks through X-Y or X-Y-Z perimeter established by one or more dynamic X-Y or X-Y-Z perimeters, the general personal shopping behavior.

It is understood by anyone who is familiar with art, that all X-Y-Z coordinates, campus maps and location calculations can be analyzed through a multitude of positioning technologies. These include WLAN, and other wireless local network, radio waves for communication between nodes or access points, sensors, GPS enable devices, triangulation, signal strength received from various access points between center and receivers.

It is also understood by anyone who is familiar with art, that each mobile device location detection is based on interferences from building structures, building materials, reflection points and other obstacles which could hinder data transmission and location accuracy. Thus, there could be one or more location technologies implemented when calculating indoor wireless access points, and indoor or building access points.

Each campus could have its own protocol setup features to establish the correlation of smart device locators relative to a store location or entity location. These protocols could be used as a guidance system, for example: to direct the customer from his/her vehicle to the nearest parking entrance or exit, to one or more entities providing the products and/or services, information regarding the products and/or services, competitive pricing for like products and/or services and all additional information requested by the potential purchasers.

In addition, it is understood by anyone who is familiar with art that foot traffic, whether moving or stationary could utilize the same guidance system and location detection technology. The setup of protocols could not only guide the smart devices to the location of the store and/or entity, but also include all information requested to make an informed product decision.

FIG. 3 is an example of wireless access and mobile positioning based on individual customizable product and/or service needs and correlating information from on campus providers of these products and/or services, in accordance with embodiments of the present invention. 302 and 304 are the boundaries of any property, such as but not limit to, retail center, shopping mall, outlet mall, schools and stadiums, etc. 306 are the individual promotional entity, such as but not limit to, retail stores, dollar stores, departmental stores and restaurants, etc. 308 are mobile devices which could include cellular devices or any wireless receiving capable devices.

Access and retrieval points could include but not limited to various GPS positioning technology, and relative perimeter mapping (geo-mapping), RFID and other sensors (gyroscopes, etc.), WiFi, repeaters or boosters, etc. Individualized set points could determine the desired boundaries of the geo-graphical grid of the campus within the outer perimeter. The inner grid defines a protected zone subsystem. One or more parameters, such as height, for each building or other structure of the campus could be provided to the TEMPT to calculate a Z coordinate in order to demonstrate the size, shape and architecture of structures as well as the locations of various levels within the structure and the location of the promotions within said structure. The TEMPT software automatically maps out the perimeters through the data point locator entries as well as include all the inter campus grid within the established perimeters. The embedded or correlated geographical data might be stored in a multitude of formats including but not limited to, Static and Kinematic pseudo-kinematic, GPS and Pseudo-static GPS, TECEF coordinates (Cartesian coordinates, Earth Centered, Earth Fixed Tri-angular and/or Concentric coordinate) etc. The campus grid map showing all structures and real time X-Y-Z promotional hotspots could dynamically determine the precise location with great accuracy of the product and/or service, including not only within the parameters of the campus but also within the interior of any structure on the campus. The alert symbol might be displayed on the campus GPS or other access mapping mechanism including Z factor map based on time expiration and urgency.

FIG. 4a is an example of a wireless promotion to attract customers based on mobile positioning and individual product and/or service needs and correlating geo-proximity, in accordance with embodiments of the present invention. 401a demonstrates potential customer traffic.

FIG. 4b is an example of a time-based promotion and discounted purchasing with pre-set requirements, in accordance with embodiments of the present invention. 401b are stores sending TEMPT message via wireless signals. Exemplified by the following:

Time based promotions and discount purchasing (TEMPT) with set point criteria's:
If customer purchases within 1 hour of receiving discount notification will receive 20% off
If customer purchases within 3 hours of receiving discount notification will receive 15% off
If customer purchases within 24 hours of receiving discount notification will receive 10% off

The smartphone, for example by employing GPS transceiver, might detect passing through the campus perimeter when traveling into the campus and could superimpose the campus map based data of the mobile device. The campus map might be transposed with the promotional “hotspot” overlay. “Hotspot” could be defined in one embodiment as high traffic and high volume of purchases in one or more location. The “hotspot” promotional example could be linked with any cellular device, protocol and system. The each virtual promotion and/or advertisement and/or discounts could be time-stamped to create a diminishing buying discount.

When the campus perimeters are entered by the organization, the GPS grid within the perimeter might be controlled by the campus servers, remote servers or combination of both. One or more servers will dynamically control the data, which could be sourced in any format, protocol and technology. In addition, various campuses could require a different set of rules unique to their product and/or service strategy. The TEMPT program could be used to customize individual needs and criteria including functionality by campus' management in order to better serve the customer needs. The TEMPT software could be networked and linked to one or more servers. The TEMPT system could be an open and/or private platform for retailers, schools, corporations, government entities, industrial parks and other organizations.

In addition in yet another embodiment, price discounting and purchase closure are correlated with time of purchase. The seller and/or organization and/or entity, in one example, could scale discounting percentage with purchase time limitation and set points.

FIG. 5 is an example of creating a hieratical promotional order to distinguish one seller's position over other sellers, for example, the first position could require a premium cost over the second and third position, etc. 501 demonstrate stores sending TEMPT messages through wireless signals. 502 are potential customers stores are competing. The first position could help an organization to gain a competitive advantage and/or promote products and/or services, in accordance with embodiments of the present invention.

FIG. 6 is an example of overall TEMPT system, in accordance with embodiments of the present invention. The smartphone reading application might, in other embodiments, provide detail of the asset when in proximity of the asset. Asset information could be in any form of text, video, audio, pictures and or multimedia regarding the painting for example or its historical linage and heritage. In addition, solar powered RFID sensors and other technologies could be used-to powered units in order to extend battery life while in transit over long distances.

GPS data pullers, also known as GPS transponders, could also be incorporated to track the asset's position at regular intervals; these devices are always-on and can be queried as often as required. GPS data pullers might be used in the case where the location of the tracker will only need to be known occasionally e.g. placed in area with higher discounts and promotions, or that does not have constant supply of power available, therefore limiting the ability to send data on a constant basis.

As described herein, some embodiments of the present invention might be implemented as a software application downloadable to a mobile device. The downloaded software application might work with existing hardware of the mobile device to implement a promotional notification alert system as described herein. For example, some embodiments might be available as an “app” or icon on the screen of the mobile device. Alternatively, some embodiments of the present invention might require special purpose hardware, and this might only be compatible with mobile devices having the promotional notification hardware.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

While the exemplary embodiments of the present invention have been described with respect to processing blocks in a software program, including possible implementation as a digital signal processor, micro-controller, or general purpose computer, the present invention is not so limited. As would be apparent to one skilled in the art, various functions of soft- ware may also be implemented as processes of circuits. Such circuits may be employed in, for example, a single integrated circuit, a multi-chip module, a single card, or a multi-card circuit pack.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bit stream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here.

It will be further understood that various changes in the details, materials, and arrangements of the parts which have been described and illustrated in order to explain the nature of this invention may be made by those skilled in the art without departing from the scope of the invention as expressed in the claims to be filed upon the USPTO utility and International filing.

The invention claimed is:

1. A system for commercial companies/organizations to send time sensitive information (TEMPT) to consumers. Wireless device that comprises a marketing or promotional alert configured to transferring data to consumers in an event consumers in a proximity location. When and where the users get into proximity location receives they will be able to receive push-notification with time sensitive promotional and or marketing message, and the discounts have time limits and are dynamically adjusted based on time restriction.

2. Apparatus for providing time sensitive information to one or more wireless transceivers coupled to a communication network, the apparatus comprising:
one or more retail databases, each retail database including pricing information for goods available from a corresponding retail location;
a server, coupled to the one or more retail databases, configured to exchange the pricing information with the corresponding retail database,
wherein the server is configured to:
set a perimeter around a geographic area containing a subset of the retail locations;
detect, via a signal sent from a corresponding wireless transceiver, a presence of the corresponding wireless transceiver within the perimeter; and
transfer time-sensitive pricing information of at least one of the subset of the retail locations to the corresponding wireless transceiver based on a proximity of the corresponding wireless transceiver to the at least one of the subset of the retail locations.
2A The apparatus of claim 2, wherein the server is configured to adjust a content of the time-sensitive pricing information of the at least one of the subset of the retail locations transferred to the corresponding wireless transceiver based on a change in the proximity, wherein the adjusted content includes marketing and promotional information.
2B The apparatus of claim 2, wherein the time-sensitive pricing information includes enriched data could include but not limit to video data, audio data, time data, discount data, and social media data.
2C The apparatus of claim 2, wherein the signal of the corresponding wireless transceiver includes user preferences for a content of the time-sensitive pricing information, include on/off setting and various functions to turn on/off notification, search method for specific product and or services for time sensitive alert.
2D The apparatus of claim 2, wherein the corresponding signal includes an alert generated by the wireless transceiver when the wireless transceiver detects its location within the perimeter based on at least one of a Global Positioning System (GPS) location information and receiving wireless base station location information.
2E The apparatus of claim 2, wherein the server is configured to adjust a content of the time-sensitive pricing information of the at least one of the subset of the retail locations transferred to the corresponding wireless transceiver based on a change in the proximity, wherein the adjusted content includes marketing and promotional information.
2F The apparatus of claim 2, wherein the server is configured to retrieve location information of one or more competing retail locations within the perimeter and, based on the proximity and the retrieved location information of one or more competing retail locations, generate a path to the at least one of the subset of the retail locations to avoid the one or more competing retail locations.

3. A system for alert notification comprising: the system is activated based on proximity location. The system is adapted to transmit an indication of time-sensitive discount and promotional/marketing message(s). When consumers into proximity location, and/or other event occurs: i) transmits an alert of the promotional and or marketing message(s) through wireless device, ii) notifies consumers and general public of the indication of promotion; iii) transmits location data automatically and/or manually to local retail server(s); iv) Based on the tracked position adjusting future transferred time-sensitive discounts and promotional message(s).

4. A method of providing time sensitive information to one or more wireless transceivers coupled to a communication network, the method comprising the steps of:
communicating, by a server, with one or more retail databases, each retail database including pricing information for goods available from a corresponding retail location;
exchanging, by the server coupled to the one or more retail databases, the pricing information with the corresponding retail database,
setting a perimeter around a geographic area containing a subset of the retail locations;
detecting, by the server via a signal sent from a corresponding wireless transceiver, a presence of the corresponding wireless transceiver within the perimeter; and
transferring, by the server though the communication network, the time-sensitive pricing information of at least one of the subset of the retail locations to the corresponding wireless transceiver based on a proximity of the corresponding wireless transceiver to the at least one of the subset of the retail locations.
4A The method of claim 4, comprising adjusting a content of the time-sensitive pricing information of the at least one of the subset of the retail locations transferred to the corresponding wireless transceiver based on a change in the proximity, wherein the adjusted content includes marketing and promotional information.
4B The method of claim 4, comprising retrieving, by the server, location information of one or more competing retail locations within the perimeter and, based on the proximity and the retrieved location information of one or more competing retail locations, generating a path to the at least one of the subset of the retail locations to avoid the one or more competing retail locations.
4C The method of claim 4, wherein the time-sensitive pricing information includes enriched data including at least one of video data, audio data, time data, discount data, and social media data.
4D The method of claim 4, wherein the signal of the corresponding wireless transceiver includes user preferences for a content of the time-sensitive pricing information.
4E The method of claim 4, wherein the corresponding signal includes an alert generated by the wireless transceiver when the wireless transceiver detects its location within the perimeter based on at least one of a Global Positioning System (GPS) location information and receiving wireless base station location information.

5. An apparatus for alarm notification used in motorized transportation, the apparatus comprising: i) utilizing sensor or GPS which automatically detects a physical location within pre-set range variable location, ii) activating notifiable alert and other indicators of promotion(s), iii) triggering of a mobile device when in alert mode; iv) Based on the tracked position adjusting future transferred time-sensitive discounts and promotional message(s).

6. A system for alerting consumers to the existence of promotional events, the system comprising: a communication network capable of sending and transmitting messages to a plurality of mobile devices to one or more mobile devices and/or other communication channels. The communication network supports: (i) data from one or more promotional alerts triggered by GPS location detection, (ii) receive and transmits enriched data such as video and audio and other data to each wireless device when in alert mode, and (iii) transmit data and send notification to one or more potential consumers; iv) Based on the tracked position adjusting future transferred time-sensitive discounts and promotional message(s).

7. A system of alerting through Computer Aided System (CAS) software or like system, comprising of: i) a system which can detect location data from a plurality of mobile devices in communication with a cellular communications network, ii) which is capable of sending encapsulated data such as but not limit to, video, audio, time, location and/or other data; iii) the system can transmit encapsulated data to one or more data collectors and/or to one or more mobile devices; iv) comprising adjusting a content of the time-sensitive pricing information of the at least one of the subset of the retail locations transferred to the corresponding wireless transceiver based on a change in the proximity, wherein the adjusted content includes marketing and promotional information.

8. A wireless transceiver, in communication through a wireless network with a server configured to access one or more retail databases and exchange pricing information with the corresponding retail database, comprising:
a processor configured to control operation of the wireless transceiver;
location detection circuitry coupled to the processor and configured to determine its location,
a radio coupled to the processor and configured to transmit first signals to, and receive second signals from, the server via the wireless network
wherein the processor is configured to:
detect its presence within a perimeter around a geographic area containing a subset of retail locations associated with the one or more retail databases based on the determined location;
transmit, via the first signals to the server, the detected presence of the wireless transceiver within the perimeter;
receive, via the second signals from the server, time-sensitive pricing information of at least one of the subset of the retail locations based on a proximity of the corresponding wireless transceiver to the at least one of the subset of the retail locations; and
provide the time-sensitive pricing information of at least one of the subset of the retail locations to a user.
8A The wireless transceiver of claim Ill, wherein the processor is configured to receive user preferences for a content of the time-sensitive pricing information and to transmit, via the first signals to the server, the received user preferences.
